(19) United States
(12) Patent Application Publication
(10) Pub. No.: US 2013/0210472 A1
(43) Pub. Date: Aug. 15, 2013

(54) SYSTEM FOR PROVIDING A GRAPHICAL USER INTERFACE ON A MOBILE DEVICE

(71) Applicant: Shiine Corp., (US)

(72) Inventors: Kevin Yan, North York (CA); Dorin Neacsu, Fenelon Falls (CA)

(73) Assignee: Shiine Corp., Toronto (CA)

(21) Appl. No.: 13/762,957

(22) Filed: Feb. 8, 2013

Related U.S. Application Data
(60) Provisional application No. 61/596,949, filed on Feb. 9, 2012.

(51) Int. Cl. H04W 4/14

(52) U.S. Cl. CPC H04W 4/14
USPC 455/466

(57) ABSTRACT

The invention is a system that provides and manages a graphical user interface on a mobile device to allow the mobile device to interact with a remote service portal using a Short Message System (SMS) interface. The system includes: a client application running on the mobile device; a Graphics over SMS (GoSMS) protocol comprising a language for exchanging commands, responses and data between software applications; a GoSMS message manager running on the mobile device; and a GoSMS server running a conversation management engine. The conversation management engine is a software application that exchanges SMS packets with the GoSMS message manager. The GoSMS message manager mediates the transmission of messages between the client and the portal by encoding GoSMS messages from the client in a number of SMS packets, and assembling multiple SMS packets received from the portal into GoSMS responses.

### PRIORITY CLAIM

The present non-provisional patent Application claims priority under 35 USC §119(e) from U.S. Provisional Patent Application having Ser. No. 61/596,949, filed Feb. 9, 2012, entitled “SYSTEM FOR PROVIDING A GRAPHICAL USER INTERFACE ON A MOBILE DEVICE,” the entirety of which is incorporated herein by reference.

### FIELD OF THE INVENTION

The present invention relates generally to systems and methods to provide a graphical user interface on a mobile device, and more particularly to systems and methods to provide a graphical user interface on a mobile device using the SMS text messaging service.

### SUMMARY OF THE INVENTION

It is an object of the invention to provide a system to allow a mobile device to interact with a remote server over SMS via a graphical user interface.

The present invention provides a system for providing and managing a graphical user interface on a mobile device to allow the mobile device to interact with a remote service portal, the mobile device having an SMS interface and a set of graphics capabilities, the system comprising:
(a) a client application running on the mobile device,
(b) a GoSMS protocol comprising a language for exchanging commands, responses and data between software applications,
(c) a GoSMS message manager running on the mobile device, the GoSMS message manager being in electronic communication with the client application, and
(d) a GoSMS server having an SMS interface and running a conversation management engine, the conversation management engine being a software application adapted to exchange SMS packets with the GoSMS message manager and being in electronic communication with the service portal,
   wherein
the client application transmits a GoSMS data request to the GoSMS message manager,
the GoSMS message manager translates the GoSMS data request into one or more SMS packets and transmits the SMS packets to the conversation management engine,
the conversation management engine assembles the SMS packets to reconstruct the GoSMS data request and transmits the GoSMS data request to the service portal,
the service portal retrieves the requested data and transmits a GoSMS response containing the requested data to the conversation management engine,
the conversation management engine translates the GoSMS response into one or more SMS packets and transmits the SMS packets to the GoSMS message manager,
the GoSMS message manager assembles the SMS packets to reconstruct the GoSMS response and transmits the GoSMS response to the client application, and
the client application extracts the requested data from the GoSMS response and displays the requested data on the mobile device according to the set of graphics capabilities.

### BRIEF DESCRIPTION OF THE DRAWINGS

FIG. 1 is a block diagram showing the major components of the system and the context it operates in.

FIG. 2 shows an embodiment of a GoSMS packet header.

FIGS. 3-8 show example screens generated by a client application on a mobile device in communication with a server application running on a GoSMS server.

### DETAILED DESCRIPTION OF THE INVENTION

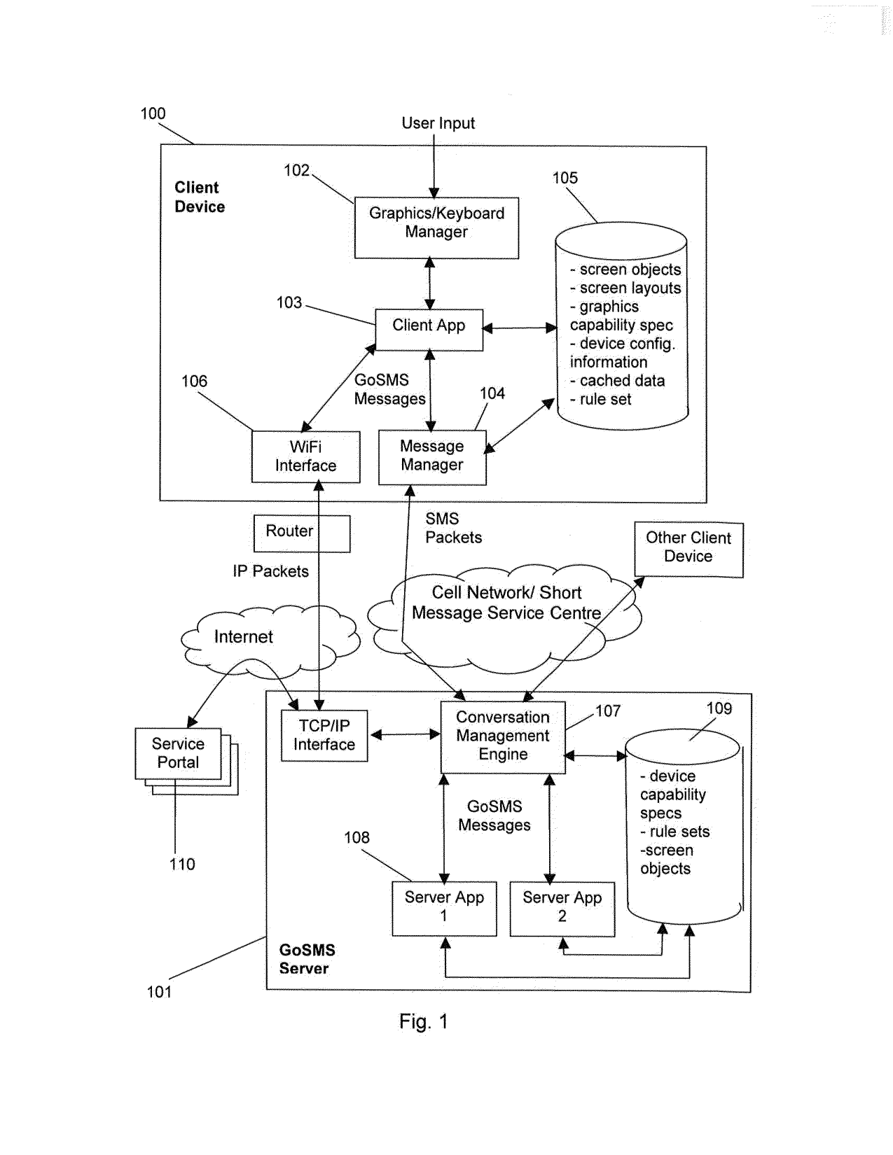

One embodiment of the invention is shown in FIG. 1. FIG. 1 depicts a client device 100 and a GoSMS server 101 connected by an SMS connection via a cell network/SMS message service centre, and by a TCP/IP connection over the internet.

The client device 100 is typically a mobile device, such as a smart phone having a set of graphics capabilities that allow the device to present a graphical interface to a user on the device's screen. Such a mobile device may be, for example, an iPhone™, an iPad™, a Galaxy Nexus™, a BlackBerry Curve™, or an HTC Rezound™. Many non-smart phones, also known as feature phones, also have sufficient capabilities to be used with the invention. The client device 100 has a graphics/keyboard manager 102 that controls the device's screen and receives input from a user, from example, from a keyboard, a touch-screen or a microphone. The client device 100 has a programmable computer processor for running software applications, or “apps”. It also has an SMS (Short Message System) interface, and may have a WiFi interface 106 also. By connecting to a wireless router, the WiFi interface 106 allows apps running on the device to communicate with remote apps via the internet using protocols such as TCP/IP.

A preferred embodiment of a GoSMS (Graphics over SMS) system comprises a GoSMS client application 103 running on the mobile device, a GoSMS protocol comprising a language for exchanging commands, responses and data between software applications, a GoSMS message manager 104 running on the mobile device, the GoSMS message manager 104 being in electronic communication with the client application, and a GoSMS server 101 having an SMS interface and running a conversation management engine 107, the conversation management engine 107 being a software application that runs on the GoSMS server 101. The conversation management engine 107 is adapted to exchange SMS packets with the GoSMS message manager 104 and is normally in electronic communication with one or more service portals 110 or server applications 108. A service portal 110 or server application 108 (collectively referred to as SPs) comprises software that may run on the GoSMS server 101, or on a separate server connected to the GoSMS server 101 by a network connection, such as by an internet connection.

An SP implements a set of functions that are accessible to a user having a client device 100 running a GoSMS client application 103 and a GoSMS message manager 104. For example, one SP may implement a social network having a number of groups or communities, and within each group or community a number of topics or threads. Then the SP may allow users to register with it and subscribe to particular groups and threads, for example, so that, using the GoSMS system, the user may post messages to those threads and automatically receive updates when other users post messages to them.

A GoSMS protocol is a protocol for transmitting commands, responses and data between a client application 103 and an SP over SMS, such as the protocol described below. The GoSMS protocol provides commands for the client application 103 to request data from an SP (GET/PULL), push data to an SP (POST/PUSH), and transmit messages directly to other users registered with the SP (MSG). SPs are identified by Uniform Resource Identifiers (URIs) and short codes, as described below.

Under user control, the client application 103 can then construct GoSMS messages to perform functions such as posting a message to a particular topic in a particular group on a social networking SP by using the command to POST/PUSH data, identifying the SP via a URI or short name, specifying an object qualifier that identifies the group and topic, and including a message. Such a GoSMS message is transmitted first to the message manager 104 which passes the message to the conversation management engine 107 via SMS, and then the conversation management engine 107 sends the message to the identified SP, which performs the requested action. The SP may be configured to send an acknowledgement message back to the client application 103 via the conversation management engine 107 and the message manager 104.

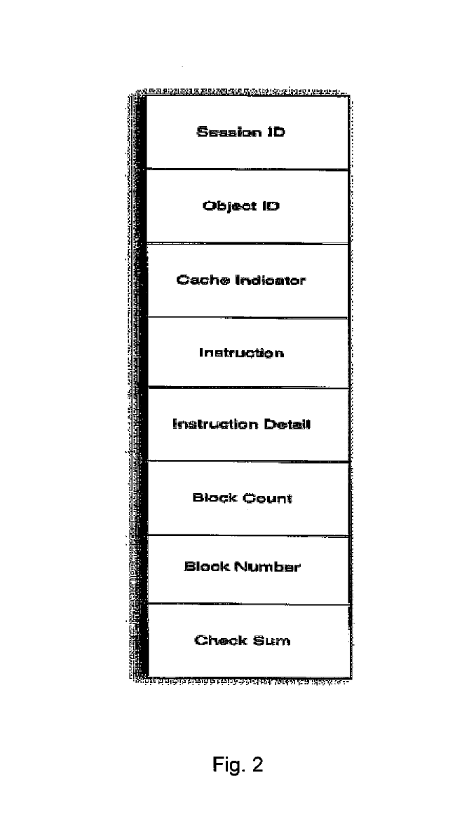

Such a GoSMS message may be much longer than the 140 byte SMS packet length. In order to send such messages via SMS, the client application 103 or conversation management engine 107 (the “transmitter”) converts the GoSMS message to one or more GoSMS packets, which are standard SMS packets that employ a GoSMS header consisting of N bytes, and a payload consisting of up to 140-N bytes. Successive 140-N bytes of the GoSMS message are placed in successive GoSMS packets as the payload, other than the last GoSMS packet, which may have fewer than 140-N bytes of payload. An embodiment of a GoSMS header is shown in FIG. 2, which includes a session ID, object ID, cache indicator, instruction, instruction detail, block count, block number, and a check sum. The block count field may indicate the number of GoSMS packets used to send the message, and the block number may indicate the number of the GoSMS packet, from 1 up to the block count. The receiver (i.e. the client application 103 when the conversation management engine 107 is the transmitter or the conversation management engine 107 when the client application 103 is the transmitter) then receives the GoSMS packets, extracts the payload and reassembles the GoSMS message. If one or more packets is not received within a pre-defined timeout period or an error in a packet is detected, e.g. by computing a checksum and comparing it to the checksum in the header, the transmitter may then send a retransmit request to the transmitter indicating the number of the block to be retransmitted.

The conversation management engine 107 may manage multiple simultaneous conversations between multiple server applications 108 or service portals 110 and multiple client devices 100.

To initiate a conversation, the client application 103 establishes a session to the server by first sending a GoSMS Handshake command to the conversation management engine 107. During conversation initiation, the client application 103 also sends a graphics capability specification to a server application 108 on the GoSMS server 101. The graphics capability specification may be stored in the client device data store 105, which may consist of writable non-volatile computer-readable memory available to the client application 103 on the client device 100. The server application 108 may compare the graphics capability specification with graphics capability information stored in the server data store 109 to determine whether the client device 100 has sufficient capability to interact with the server application 108. Any irreconcilable differences will cause a termination of the session.

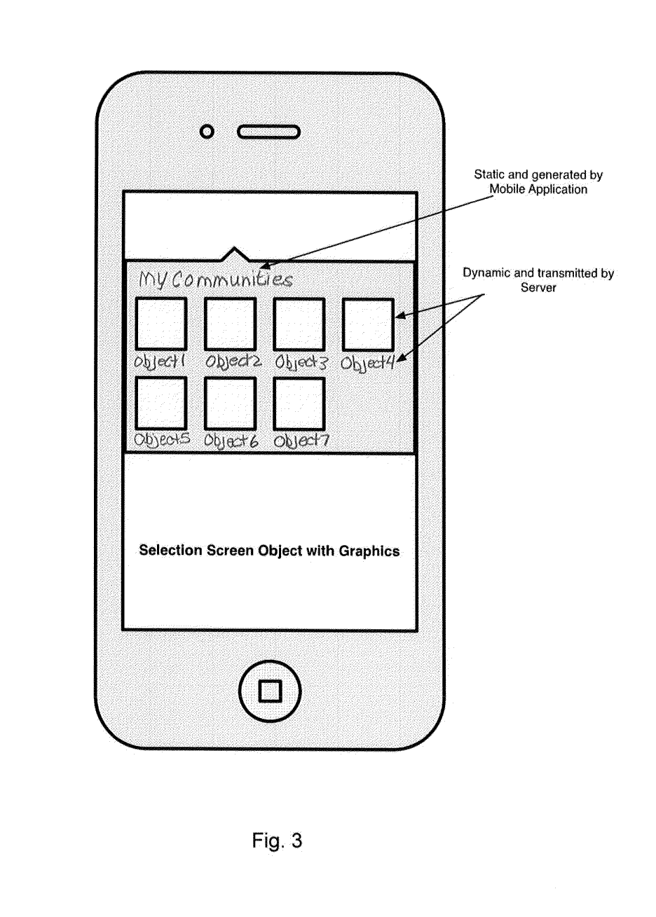

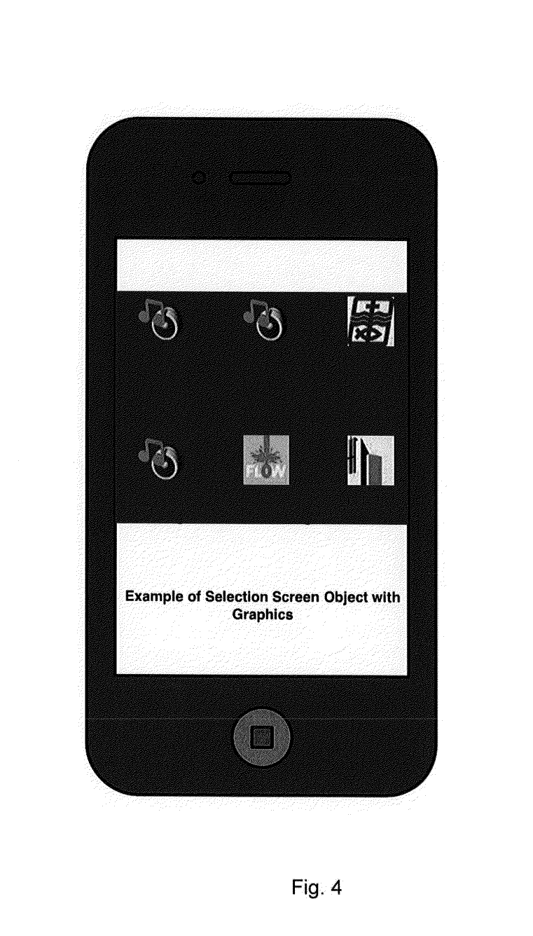

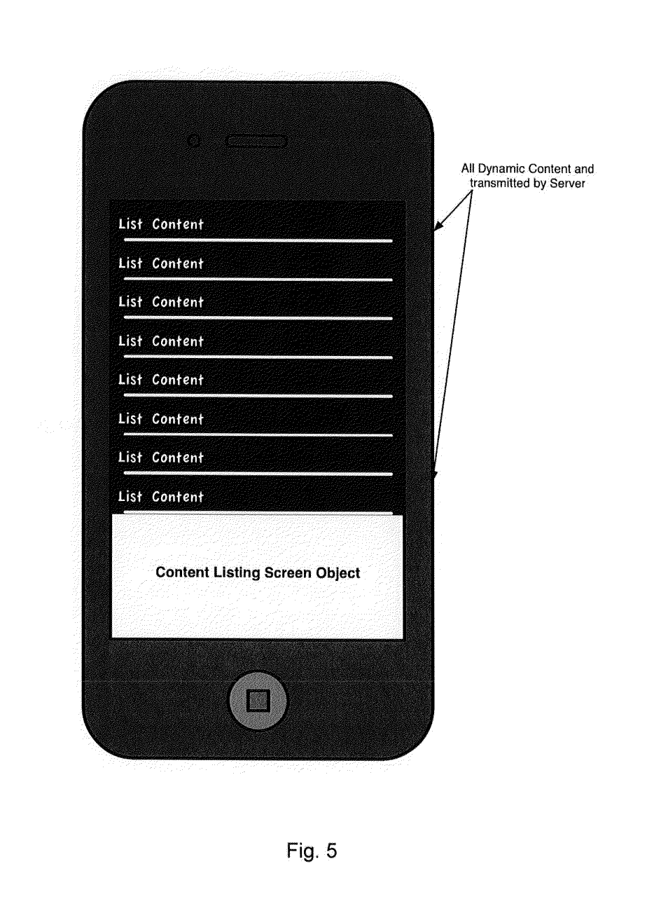

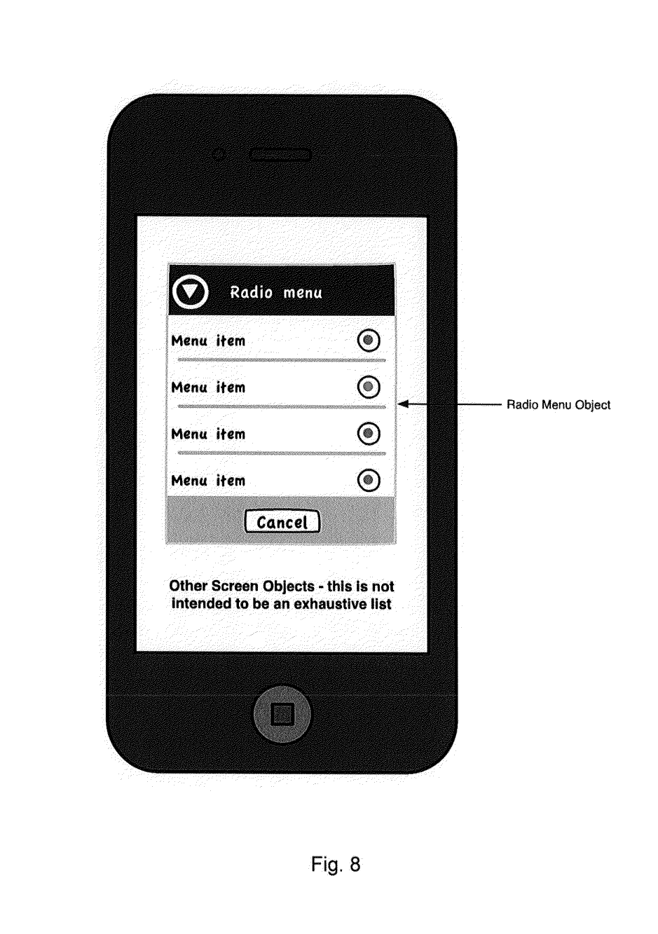

The client application 103 renders the display on the client device 100 according to layouts and screen objects that are stored in the device data store 105, or which may be transmitted or specified by the server application 108. Examples of such displays are shown in FIGS. 3-8. In general, the layout specifies where on the display screen objects are to be placed. Every screen object associated with a version of a client application 103 is labelled along with its associated refreshable data. The data can include text and graphics for example. Refreshable data includes all aspects of a screen object that can change as a result of data sent by the server or as a result of data input by the user.

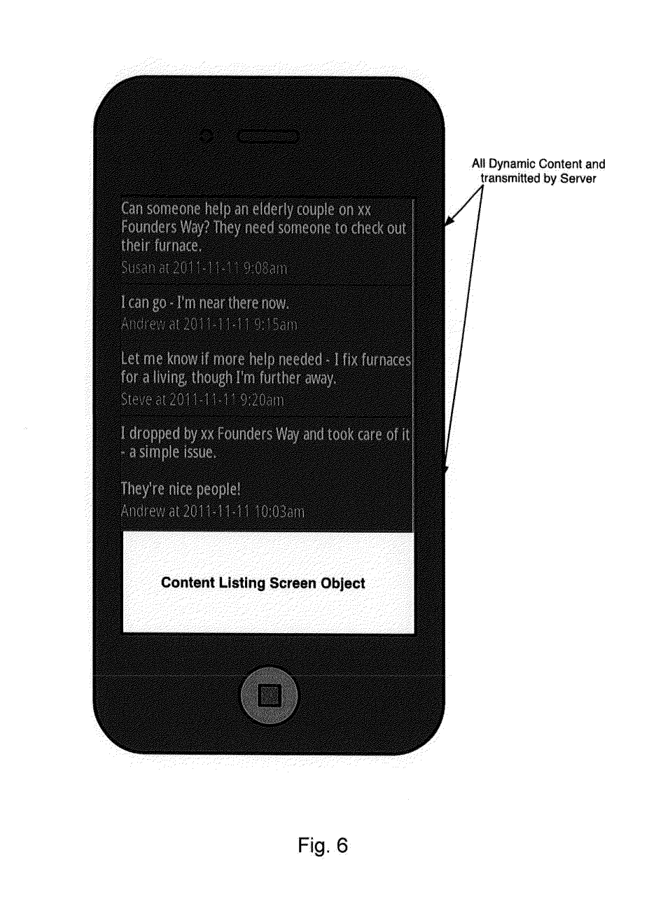

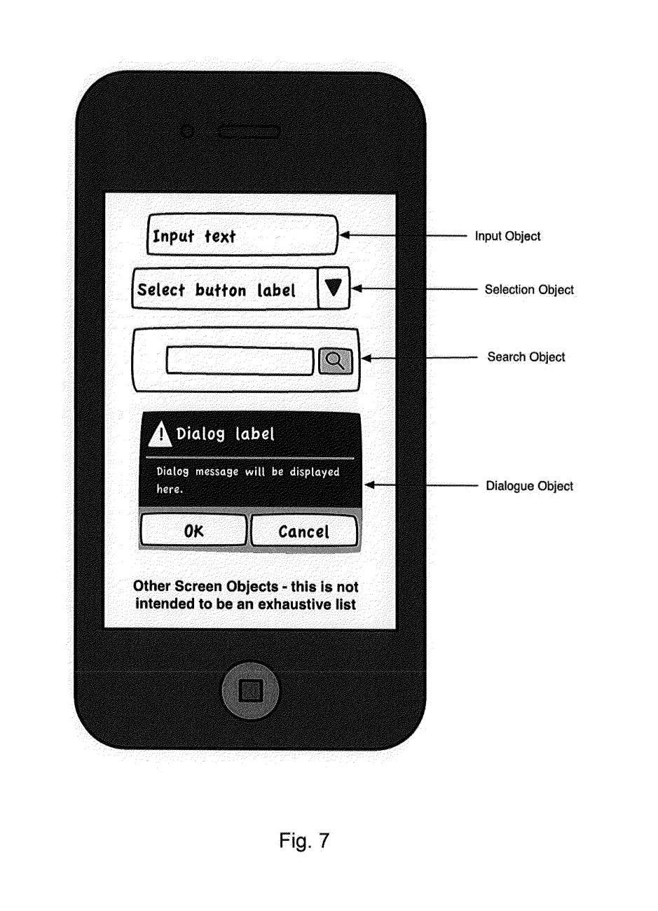

Screen objects may be static or dynamic. Static screen objects do not change and can be stored on the client device data store 105 to avoid the need to request them from the server application 108. Dynamic screen objects include at least a portion that changes over time, for example in response to user input or information sent from the server application 108. For example, FIG. 7 shows an input object, which is a text box that the user may select and then use a keyboard or touch-screen to enter text into. Some dynamic screen objects, such as the message objects shown in FIG. 6, display dynamic content provided by the server application 108, such as messages in a group topic.

In order to minimize the transmissions and optimize communications, only changed information (i.e. deltas) is sent. That is, if only a single screen object that accepts user input is present in the display, then only the ID associated with that single screen object and the associated changed data is transmitted to the server application 108. Similarly if requests from the client device 100 result in a limited set of changes on the client device 100 screen, but not all screen elements have changed, then only IDs and data associated with the limited set of changes are sent by the server application 108 to the client application 103.

The client device data store 105 is used as a cache to increase performance. The client device configuration information stored in the client device data store 105 is used by the server application 108 to determine the most effective communication method and GoSMS Packets. The conversation management engine 107 is responsible for working through a Rule Set for each client application 103. Further information about GoSMS Rule Sets is provided below. The GoSMS Rule Set is established during the GoSMS Handshake. The GoSMS Rule Set is synchronized on both the server and the mobile device.

For client devices 100 with a WiFi interface 106, the client application 103 may detect the availability of a WiFi connection and transmit GoSMS messages using WiFi to a GoSMS server 101. This would typically be done using TCP/IP over the internet.

Generally, a computer, computer system, client or server, as will be well understood by a person skilled in the art, includes one or more computer processors, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

Generally, a computer, computer system, computing device, client or server, as will be well understood by a person skilled in the art, includes one or more than one computer processor, and may include separate memory, and one or more input and/or output (I/O) devices (or peripherals) that are in electronic communication with the one or more processor(s). The electronic communication may be facilitated by, for example, one or more busses, or other wired or wireless connections. In the case of multiple processors, the processors may be tightly coupled, e.g. by high-speed busses, or loosely coupled, e.g. by being connected by a wide-area network.

A computer processor, or just “processor”, is a hardware device for performing digital computations. A programmable processor is adapted to execute software, which is typically stored in a computer-readable memory. Processors are generally semiconductor based microprocessors, in the form of microchips or chip sets. Processors may alternatively be completely implemented in hardware, with hard-wired functionality, or in a hybrid device, such as field-programmable gate arrays or programmable logic arrays. Processors may be general-purpose or special-purpose off-the-shelf commercial products, or customized application-specific integrated circuits (ASICs). Unless otherwise stated, or required in the context, any reference to software running on a programmable processor shall be understood to include purpose-built hardware that implements all the stated software functions completely in hardware.

Multiple computers (also referred to as computer systems, computing devices, clients and servers) may be networked via a computer network, which may also be referred to as an electronic network or an electronic communications network. When they are relatively close together the network may be a local area network (LAN), for example, using Ethernet. When they are remotely located, the network may be a wide area network (WAN), such as the internet, that computers may connect to via a modem, or they may connect to through a LAN that they are directly connected to.

Computer-readable memory, which may also be referred to as a computer-readable medium or a computer-readable storage medium, which terms have identical (equivalent) meanings herein, can include any one or a combination of non-transitory, tangible memory elements, such as random access memory (RAM), which may be DRAM, SRAM, SDRAM, etc., and nonvolatile memory elements, such as a ROM, PROM, FPROM, OTP NVM, EPROM, EEPROM, hard disk drive, solid state disk, magnetic tape, CDROM, DVD, etc.). Memory may employ electronic, magnetic, optical, and/or other technologies, but excludes transitory propagating signals so that all references to computer-readable memory exclude transitory propagating signals. Memory may be distributed such that at least two components are remote from one another, but are still all accessible by one or more processors. A nonvolatile computer-readable memory refers to a computer-readable memory (and equivalent terms) that can retain information stored in the memory when it is not powered. A computer-readable memory is a physical, tangible object that is a composition of matter. The storage of data, which may be computer instructions, or software, in a computer-readable memory physically transforms that computer-readable memory by physically modifying it to store the data or software that can later be read and used to cause a processor to perform the functions specified by the software or to otherwise make the data available for use by the processor. In the case of software, the executable instructions are thereby tangibly embodied on the computer-readable memory. It is the express intent of the inventor that in any claim to a computer-readable memory, the computer-readable memory, being a physical object that has been transformed to record the elements recited as being stored thereon, is an essential element of the claim.

Software may include one or more separate computer programs configured to provide a sequence, or a plurality of sequences, of instructions to one or more processors to cause the processors to perform computations, control other devices, receive input, send output, etc.

It is intended that the invention includes computer-readable memory containing any or all of the software described herein. In particular, the invention includes such software stored on non-volatile computer-readable memory that may be used to distribute or sell embodiments of the invention or parts thereof.

It should be understood that the above-described embodiments of the present invention, particularly, any “preferred” embodiments, are only examples of implementations, merely set forth for a clear understanding of the principles of the invention. Many variations and modifications may be made to the above-described embodiment(s) of the invention as will be evident to those skilled in the art.

Where, in this document, a list of one or more items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the listed item(s), and alternatives to the item(s), in the list that a skilled person would understand would be suitable for the purpose that the one or more items are listed.

The words “comprises” and “comprising”, when used in this specification and the claims, are to used to specify the presence of stated features, elements, integers, steps or components, and do not preclude, nor imply the necessity for, the presence or addition of one or more other features, elements, integers, steps, components or groups thereof.

### SMS as a Transport Protocol

SMS message length is 140 bytes (160 characters in GSM 7 bit alphabet [http://en.wikipedia.org/wiki/GSM_{—}03.38]).

### GoSMS

GoSMS™ is an application protocol that allows SMS enabled Mobile Devices (MD) to interact with various Service Portals (SP) in a concise manner. A Service Portal is a web application providing services to end users.

The GoSMS protocol is designed to use both binary and text SMS as the transmission media, thus it can also be used by a user from a standard SMS messenger application on the MD.

A mobile client application (MCA) can use GoSMS to its full extent and make use of the SMS binary packets to transmit and interpret visual rich data. The mobile client application can also use GoSMS over TCP/IP on data enabled MDs.

GoSMS Packets

The GoSMS packets can originate from MDs or from SPs.

The packets originating from MDs (MD Packets) are categorized as follows:
GET/PULL—used to request configuration or dynamic data from SPs. These packets will be followed by a response from the SP;
POST/PUSH—used to push data to SPs. These packets may or may not get an ACK/ERR response from the SP. Can also be sent as a response to SP's PUSH packets. They must contain the SP PUSH short code to be valid, otherwise they will be classified as ROGUE. These packets may get a follow-up response from the SP;
MSG—these are direct messages, ignored by the processing engine of the SP and sent directly to the specified user. These packets will not get a response;
ROGUE—these packets are either SPAM or inadvertently sent messages or other valid indirect messages that will be stored and filtered manually by the Shiine Message Center site. These packets, as the MSG packets, will be ignored by the processing engine and will not get an automated response.

The packets originating from SPs (SP Packets) are categorized as follows:
QRESPONSE—these are responses to GET/PULL packets;
PUSH—these packets are sent to the MDs when SP events occur and the MD users are subscribers to the event. These packets include also the responses of Shiine Message Center to ROGUE MD packets. If an MD response is mandated, the message will contain an SP object short code that must be included in the response.
ACK/ERR—if required/configured they will acknowledge the successful/not successful completion of an SP action

### MD Text Packets

A typical MD text packet is comprised of an optional command verb (1 character), an optional object qualifier and the optional packet data (message):

[<command verb>][<object qualifier>/][<message>]
The command verb defines the action to be performed on the SP.
The object qualifier uniquely identifies the SP and the SP object the command applies to.
The message specifies the object data.

Accepted alternatives to the above syntax include:

[<object qualifier>][<command verb>][<message>]
[<object qualifier>/][<message>][<command verb>]

Examples include:
?social/my community/topic/
social/com?
social/my community/topic/My post!

### Command Verbs

The syntax for command verbs is <command verb>:={?|!|@}
?—GET/PULL—ask for data from the SP;
!—POST/PUSH—push data to the SP;
@—MSG—plain SMS, bypassing the processing engine on the SP.

### Object Qualifiers

Object Qualifiers have to cover a wide variety of applications and application objects and most of the time they are dynamic in nature. For example a push from the SP will contain an object qualifier (short code) that must be included in an expected MD response.

A qualifier can be:
short code—a combination of characters and numbers (preferably not more than 10-15) built dynamically on the SP side and representing a unique SP object. Numbers are used to eliminate duplicates. This form will mostly be used in a PUSH message from the SP.
descriptive (mURI)—it is a modified version of an URI adjusted and streamlined for SMS use. Being explanatory, provides a more meaningful object identification, therefore it will mostly be used in a standard SMS messenger application on the MD side.
shorthand (sURI)—it has a similar syntax as the mURI but uses abbreviations for the URI specific parts. The abbreviations are either predefined in a mapping table or well known SMS shorthands.

A combination of the shorthand and descriptive qualifiers can be used and is accepted.

### Qualifier Syntax

Qualifier syntax is: <object qualifier>:={[ ]|[wifi:/]}<SP>[/object hierarchy>]
wifi:/—specifies whether the TCP/IP is used as the transport protocol. Used by the mobile client application to signal the SP that long responses can be transmitted and there is no need for filtering and/or pagination. Receiving multiple or large images on the MD is an example of such usage.
<SP>:={<SP name>|<SP short code>}—short codes will be found in a mapping table.
<object hierarchy>—a path pointing to the unique SP object. It's acceptable syntax is:
   {[<parent object type>[:<parent object id>]/] . . . <child object type>[:<child object id>]}
   {[<parent object shorthand>/]É<child object shorthand>}

Examples include
?soc/c:123/t:234/msg/
   the above command will retrieve the messages for the topic id 234 within the community id 123 on the social site using SMS.
?social/PCA Community/Teachers/msg/
   this command is similar to the above but it is using names for the objects.
@social/I am on route to the Caribbean
   this command will update the user personal message on the social site using SMS. The / is used to specify that what follows is an SP name
@social/johndoe/Hello John. Send me a note when you receive this.
   this sends a message to johndoe using the MD wireless connection to communicate with the SP
XMAS 12001 y
   this is an MD response to an SP PUSH specifying the XMAS12001 as an object short code. This is dynamic and specific to the SP.
!social/c:123/t:234/msg/ There is a teachers meeting now
   this adds a message to the topic 234 within the community 123

### Object Type Mapping Table

The following object type mapping table is an example, a starting point for an SP providing social networking services. In a real word scenario this will be updated and extended manually or automatically (semantically) to accommodate various SP services and their object categories.

| Character | Shorthand | Object |
|---|---|---|
| c | grp/com | group/community |
| f | frnd | friend/neighbor |
| t | tpc | topic |
| k | cat | category |
| m | msg | message/post |
| p | pic | picture/logo |

### Message/Data

Unless the message follows the command verb, it will be separated by a space from the object qualifier. Note that the object qualifier in such cases has to end with a /. If more than one set of data is needed each set will be separated by “&”:

<message>:=<data set 1>[&<data set 2>] . . .

### Reserved Symbols

The reserved symbols include:
/—URI parts separator
:—object type and ID separator
   |—data set separator within the message
?—command verb
!—command verb
@—command verb

NOTE: Space character, individually, is not a reserved symbol. However, if it follows a URI part separator, “/”, it is interpreted as a separator between the object qualifier and the message.

### GET/PULL Packets

GET/PULL Packets packets are used to request data from the SP. The packet has to include ? as the command verb, and if necessary an object qualifier and one or more data filters as the message.

Examples include:
?social/c/—get user's community
?social/f/—get user's friends
?social/t/m/18—get messages for topic with identifier 18
?social/deals—this searches deals on an SP
? deals—this searches deals on all SPs

### POST/PUSH Packets

POST/PUSH packets are used to send data to the SP. If not used as a response to an SP PUSH or as a general SP subscribe/unsubscribe the packet has to contain ! command verb, an object qualifier and the data. If used as a response to a PUSH, it has to use the short code and the response message.

Examples include:
mcdxmas12 y
mercedesoil 1
shiine o
!social/c:123/t:234/m/ This is a post

Reserved Keywords are shown in the table below:

| Keyword | Meaning |
|---|---|
| i | Subscribe |
| 1 | Subscribe |
| o | Unsubscribe |
| 0 | Unsubscribe |
| stop | Unsubscribe |

### MSG Packets

MSG packets are used to send SMS messages that do not require SP data. The SP will map the object to a mobile device or to the user's own profile based on the object qualifier following the @ command verb. The rest of the message will be passed on as is.

A list of valid object qualifiers include but is not limited to:
shiine
admin
administrator manager
webmaster
em3

The corresponding message will be forwarded to the Message Center. For all other invalid (non-existent) objects the message will be stored for later analysis, and its content ignored (no notification); same as with other ROGUE packets.

### SP Text Packets

SP Text Packets originating from the SP are various, dynamic, and most of the time do not follow a specific syntax but rather identify themselves to the MD.

### Packet Identifier

SP packets require an identifier to be sent along with the message. The identifier can be a:
short code—SP packets that require a response from the MD will have a short code (unique object qualifier) clearly specified in the message content. An MD reply has to include the short code;
SP name—generic, traceable messages that do not require a response from the MDs;
MD request identifier—these packets are responses to GET/PULL messages from MDs and they usually duplicate the object qualifier of the request using the shorthand format. This way the response can be matched with the request;
originator name—specifies an SP entity that generated the message. For example a user or a company name or short name.

A semantically valid combination of identifiers in a single message is accepted (i.e. ₐₙ SP name with a short code).

Examples include:
Shiine: Could you help? Reply food4hless y or n.
   “Shiine” is an “originator”. It identifies the message source.
   “food4hless” is the short code required of the MD reply. Also, “y” or “n” is required for a valid message
Shiine: Your unsubscribe request has been processed. You will not receive SMS messages from Shiine
   an SP name example. No response is necessary.
shiine/c:123/t:234/m? {id..message}
1..Meeting at 10:30 on Jan. 31, 2012.
2..Now requiring participants
   A response to a “?shiine/PDA Teachers/Meetings/msg” request

Reserved Keywords and Symbols include:

| Keyword/Symbol | Meaning |
|---|---|
| y | Yes |
| n | No |
| . . . | Field separator |
| newline | Data set separator |

### QRESPONSE Packets

QRESPONSE packets are returned by SP as a response to GET/PULL packets from MD. They start with an MD request identifier followed by the result syntax and the actual result. A newline is used to separate distinct data sets.

The SP response generation process consists of:
1. Parsing the MD request
2. Querying the data applying any MD request filter and any SP defined filters
3. Constructing the response
   The response will be constructed in accordance to the Ruleset established at the GoSMS Handshake.

The returned data is a matrix transposed to a plain string (SMS) message. The construct of the message is as follows:
{{<col name>[..<col name>]...\n}}<ddata>[..<data>]...\n—
   where “\n” is the newline symbol.

Examples are:
?social/topic will return:
   {id..summary}
   1..Jobs
   2..Good Deals
?social/com will return:
   {id..parentid..name}
   1.. ..Employers
   2.. ..Gas News
   3..2..Deals

### PUSH Packets

PUSH packets are pushed to MD from the SP based on user subscription options. These packets are usually created as free text, but if responses from the MDs are necessary they will contain a short code and specific instructions for the user on how to respond. The short code is generated dynamically and uniquely identifies the SP object.

### GoSMS Rule Sets

The GoSMS Rule Set is established during the GoSMS Handshake. The GoSMS Rule Set is synchronized on both the server and the mobile device. The GoSMS Rule Set is used to govern conversations between a particular mobile device and the Conversation Management Engine.

Examples of components in the GoSMS Rule Set are (in no particular order and does not represent an exhaustive list):
Maximum graphics size to be sent over SMS
Maximum text information to be sent over SMS (can be represented in the number of SMS packets)
Use WIFI first if available
Use Data—possible values (if available, based on a transmission limit, if SMS fails)

The GoSMS Rule Set is defined by combining mobile device configuration information, user defined configuration information and server configuration information for a specific mobile device. The server configuration information can be used to override user defined and mobile device configuration information in some situations.

Examples of mobile device configuration information (in no particular order and does not represent an exhaustive list):
Hardware
   Manufacturer
   Model
   Operating System
   Operating System Version
Software
   A list of software that could be employed by GoSMS
   A list of software that could conflict with GoSMS
Wireless Carrier
Version of GoSMS Message Manager
WIFI enablement
Data enablement
GPS enablement
User Defined Configuration Information:
   Graphics over SMS—possible values (Never, WIFI only, Always, System Decides)
   Data Reuse—possible values (Always, Never, System Decides)
   Data Limits
   Graphics Store Sync Frequency
   Message Store Sync Frequency

Examples of server side configuration information pertaining to a mobile device (in no particular order and does not represent an exhaustive list):
Hardware
   Manufacturer
   Model
   Operating System versions supported
   Software
   A list of software that could be employed by GoSMS
   A list of software that could conflict with GoSMS
Versions of GoSMS Message Manager supported
A list of screen objects (and their attributes) associated with the version of the GoSMS Message Manager running on a particular mobile device
WIFI enablement
Data enablement
GPS enablement
Data Reuse controlled by server (overrides mobile device setting)
Data Limits controlled by server (overrides mobile device setting)
Timeout (how long to wait on a transmission)
Retry (how many times to retry before terminating communication session)
Graphics Store Last Sync
Message Store Last Sync

The scope of the claims that follow is not limited by the embodiments set forth in the description. The claims should be given the broadest purposive construction consistent with the description as a whole.

What is claimed is:

1. A system for providing and managing a graphical user interface on a mobile device to allow the mobile device to interact with a remote service portal, the mobile device having a Short Message System (SMS) interface and a set of graphics capabilities, the system comprising:
(a) a client application running on the mobile device;
(b) a Graphics over SMS (GoSMS) protocol comprising a language for exchanging commands, responses and data between software applications;
(c) a GoSMS message manager running on the mobile device, the GoSMS message manager being in electronic communication with the client application; and
(d) a GoSMS server having an SMS interface and running a conversation management engine, the conversation management engine being a software application adapted to exchange SMS packets with the GoSMS message manager and being in electronic communication with the service portal.

2. The system of claim 1, wherein
the client application transmits a GoSMS data request to the GoSMS message manager,
the GoSMS message manager translates the GoSMS data request into one or more SMS packets and transmits the SMS packets to the conversation management engine,
the conversation management engine assembles the SMS packets to reconstruct the GoSMS data request and transmits the GoSMS data request to the service portal,
the service portal retrieves the requested data and transmits a GoSMS response containing the requested data to the conversation management engine,
the conversation management engine translates the GoSMS response into one or more SMS packets and transmits the SMS packets to the GoSMS message manager,
the GoSMS message manager assembles the SMS packets to reconstruct the GoSMS response and transmits the GoSMS response to the client application, and
the client application extracts the requested data from the GoSMS response and displays the requested data on the mobile device according to the set of graphics capabilities.
